(19) United States
(12) Patent Application Publication
(10) Pub. No.: US 2026/0324776 A1
(43) Pub. Date: Oct. 22, 2026

(54) Waste handbag/glove bag

(71) Applicant: Thomas James Chleborad, JR., SAINT JOSEPH, MO (US)

(72) Inventor: Thomas James Chleborad, JR., SAINT JOSEPH, MO (US)

(21) Appl. No.: 19/186,156

(22) Filed: Apr. 22, 2025

(51) Int. Cl. A41D 19/00; B65F 1/00

(52) U.S. Cl. CPC A41D 19/0075; B65F 1/0006; B65F 2210/167; B65F 2230/00; B65F 2240/136; B65F 2250/1143

(57) ABSTRACT

The present invention relates to a glove or handbag designed for the hygienic collection of pet waste. The device features sealed sides with an opening at the top, which includes a secure sealing mechanism for closing and containing the collected waste. The unique design ensures ease of use by allowing the user to don the glove or handbag, collect pet waste, and then seal the top to contain the waste securely. This invention provides an efficient, sanitary, and convenient solution for pet owners, minimizing contact with waste and ensuring proper disposal. The glove or handbag is particularly suitable for outdoor environments, such as park or residential areas, where quick and hygienic waste disposal is essential.

### PRIOR ART

U.S. Pat. No. 5,704,670 Jan. 6, 1998 Donald Well Surplus 1/1998
U.S. Pat. No. 6,116,668 Sep. 12, 2000 Nicholas Carpol Page 4, Sect 55
U.S. Pat. No. 0,193,539 Aug. 31, 2006 Andrea Small Page 2, Lines 8,12
U.S. Pat. No. 0,229,595 Aug. 11, 2006 Stephen Connolly Page 3, Claims
U.S. Pat. No. 6,481,766 Nov. 19, 2002 May/Ayers Column 2, Sect 55

### BACKGROUND OF THE INVENTION

In the early 1970s, the growing population of canines in the cities like New York was becoming a major political issue. The waste left by these dogs was estimated to be around 500,000 pounds a day, and it was impacting the quality of life for residents. Animal waste is an environmental pollutant and a human health hazard. When left on the ground, it eventually breaks down and washes into the water supply, polluting rivers, streams, and other local waterways. According to the Environmental Protection Agency, waste from 100 dogs over 2-3 days can contain enough bacteria to temporarily close a bay and watershed areas to swimming or shell fishing within 20 miles. Today the practice of picking up after your animal has become widely accepted, and the law in most places. The development of various disposable bags has made the task more manageable. There are few bags or handbags out, that manage waste and cleanup, that are economically feasible and affordable to manufacture. I believe there is a lack of options to pick waste and dispose of it quickly, efficiently, and contactless.

### BRIEF DESCRIPTION OF DRAWINGS

FIG. 1 is a side view of the glove bag or handbag in accordance with a first embodiment of the invention.

FIG. 2 is a side view of the glove bag or handbag in accordance with a second embodiment of the invention.

FIG. 3 is a front or rear view of the glove bag or handbag in accordance with the third embodiment of the invention.

FIG. 4 is a side view of a hand being inserted into the glove bag or handbag.

FIG. 5 is a side view of the glove bag or handbag being worn and being used to pick up animal waste.

FIG. 6 is a side view of the glove bag or handbag being everted.

FIG. 7. Is a side view of the glove bag or handbag after being sealed.

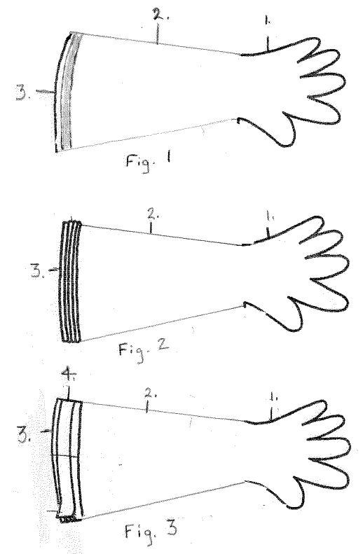

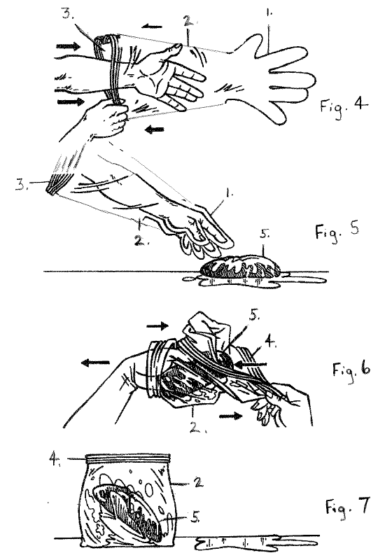

### DRAWING REFERENCE NUMBERS

1. Glove Portion
2. Glove bag cuff or Handbag cuff
3. Open End of Bag
4. Adhesive Strip/Seal
5. Animal waste or general waste

### DETAILED DESCRIPTION OF THE INVENTION

1. The present invention is a waste collection handbag or glove bag that is impermeable, sanitary, inexpensive, eversible, flexible, and sealable.
2. The glove can be made from any common useful paper, plastic, such as HDPE, LDPE, or polypropylene. The invention may also be made from Oxo-biodegradable version of both polyethylene and polypropylene.
3. In its first embodiment the present invention is made from two sheets of material, one for the top side the other for the palm side.
4. The top and bottom sheets are trimmed in a handbag or glove bag shape, bonded using process such as heat sealing. The open end of the handbag or glove bag is wide enough so the invention may be everted.
5. A handbag or glove bag has a strip that is attached to the handbag or glove bag near the opening that may be removed to seal the handbag or glove bag.
6. The handbag or glove bag is everted after picking up waste to contain it and once everted with waste inside the bag the seal strip may be peeled and bag closed
7. The handbag or glove bags may be different sizes or different shapes depending on consumers need.
8. The handbag and glove bags are different and unique from previous art due to its use for animal waste or waste in general and may be used on either right or left hand.
9. After waste is picked up with handbag or glove bag, the glove is everted over the hand, after which the peel strip is removed from the seal strip which may be an adhesive strip, eliminating, folding, twisting, and tying enabling the person a faster cleaner experience.

1. The glove length comes to mid-forearm but is not limited to that length. The open end is where the hand is inserted, it is wider than the area at the wrist area. this will provide a way of everting the bag over the hand and contain the waste efficiently and cleanly.

2. The handbag once pulled over the hand with waste inside can then be sealed by
peeling away the seal strip and the strip adhering to opposite side of the handbag.

3. The handbag is not limited to just this basic design or seal process but can be modified for specific use.

4. The handbag can be worn on either hand and the seal will work the same using either hand but can be modified or used differently.

5. Studying current manufacturing processes show how complicated and non-cost effective most glove bags are, few have made it to manufacture. Current manufacturing machinery and industrial engineers using synthetic or natural plastics offer new possibilities with products with cost efficient means.
